(19) United States
(12) Patent Application Publication
(10) Pub. No.: US 2011/0020573 A1
(43) Pub. Date: Jan. 27, 2011

(54) POLYAMIDE COMPOSITION CONTAINING IONOMER

(75) Inventors: Richard T. Chou, Hockessin, DE (US); Herbert Vernon Bendler, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/507,758

(22) Filed: Jul. 22, 2009

(51) Int. Cl. C08L 77/06; B32B 5/02; B32B 1/08

(52) U.S. Cl. 428/36.1; 525/183; 442/59

(57) ABSTRACT

A composition and an article therewith are disclosed wherein the composition comprises or is a blend that comprises a polyamide, an ionomer of an ethylene copolymer containing a monocarboxylic acid and a dicarboxylic acid or derivative thereof, and a sulfonamide.

The invention relates to a composition comprising polyamide, ethylene copolymer and plasticizer and to articles prepared from the composition.

### BACKGROUND

Polyamides (nylons) are widely used in many industrial applications. Through modification, properties of polyamides can be tailored for the intended performance. For example, flexibility is not an inherent feature for a polyamide material. For some applications, such as auto tubing or hoses, flexibility is an important feature. Plasticizers that break down the hydrogen-bonding of polyamides are known to be effective in enhancing the flexibility of polyamides. Polyamide compositions plasticized with sulfonamides such as N-Butylbenzene sulfonamide are known (U.S. Pat. No. 4,801,633 and U.S. Pat. No. 6,190,769). Plasticized nylon-11 and nylon-12 are found in many applications, such as tubing, hose, pipe, film, injection molded parts, etc.

Depending on the chemical nature of the polyamides, exposure to inorganic salt solutions has been known to cause stress cracking of polyamides (“salt stress cracking”, see M. G. Wyzgoski and G. E. Novak, Journal of Material Science, 1707-1714 (1987); Stress Cracking of Nylon Polymers in Aqueous Salt Solutions). Polyamides with a lower ratio of amide to methylene groups, such as nylon-11 and nylon-12, are not susceptible to salt stress cracking. On the other hand, polyamides with a higher ratio of amide to methylene groups, such as nylon-6 and nylon-66, are highly susceptible to cracking when exposed to salt solutions. The presence of plasticizer in a polyamide with a higher ratio of amide to methylene groups makes it even more susceptible to salt stress cracking. Thus, highly flexible nylon-6 modified with plasticizer has only limited industrial application due to its poor resistance to salt stress cracking. Instead, plasticized nylon-11 and nylon-12 with excellent salt stress crack resistance have been used. However, products based on nylon-11 and nylon-12 are expensive because of the high cost of those polymers.

US2007/0083033A1 discloses a hydrolysis resistant copolyamide having a melting point less than or equal to 240° C., at least 30 μeq/g of amine ends and an inherent viscosity of at least 1.2, optionally containing plasticizer.

While achieving flexibility, the incorporation of plasticizers may compromise some of the other properties of polyamides. For example, the plasticized polyamide is still deficient in low temperature impact toughness. As the amount of plasticizer in the polyamide composition increases, the fugitive nature of plasticizers becomes more of a concern. Plasticizers are known to leach out of compositions over time and may lead to a degradation of properties including flexibility. Also, leaching of plasticizers may lead to contamination of materials in contact with the plasticized composition.

It is a common practice in industry to modify polyamides with impact modifiers, such as maleated EP rubber. Polyamides modified with impact modifiers may achieve excellent low temperature toughness. For example, U.S. Pat. No. 5,648,423 discloses polyamide compositions toughened with a graft-modified ethylene/1-butene copolymer. The presence of an impact modifier of low modulus (soft modifier) also enhances the flexibility, but it is much less effective than the incorporation of plasticizer. Also, the presence of soft impact modifiers can compromise abrasion and scratch resistance, which are desirable inherent attributes of polyamides.

The incorporation of both impact modifier and plasticizer has been reported for attaining both flexibility and low temperature toughness and possibly other benefits. One of the trade-offs, however, is the loss of the optical clarity due to the heterogeneous nature of the modified polyamide. U.S. Pat. No. 6,913,043 discloses compositions comprising polyamides such as PA-11 and PA-12, 4 to 10 weight % of plasticizer and optionally up to 25 weight % of nitrile butadiene rubber, useful for pipes used in offshore oil and gas production and other applications. For these applications, clarity is not an issue, but clarity can be very important for other applications, such as packaging or wear layers on decorative surfaces such as flooring. This approach still falls short in attaining a highly flexible, toughened polyamide with good optical clarity.

Accordingly, it is desirable to develop a highly flexible polyamide with good optical clarity, high toughness, and high abrasion and scratch resistance. It is also desirable that such compositions make use of more readily available polyamides such as nylon-6, which has much lower cost.

Recently a new type of ionomer has been disclosed in U.S. Pat. No. 5,700,890, wherein neutralized ethylene acid copolymers are prepared using dicarboxylic acids, or derivatives thereof, as monomers in addition to the monocarboxylic acids used in typical ionomers. These “anhydride ionomer” copolymers may further contain an alkyl acrylate comonomer.

US2005/0203253A1, 2005/020762A1, and 2006/0142489A1 disclose polyamides toughened with anhydride ionomers.

### SUMMARY OF THE INVENTION

A composition or a blend comprises, consists essentially of, consists of, or is produced from, based on the weight of the composition, about 40 to about 70% of polyamide, about 60 to about 30% of an ionomer, and about 2 to about 20% of a sulfonamide wherein the ionomer comprises or is a copolymer derived from in-chain copolymerized comonomers of ethylene, at least an α,β-unsaturated C₃-C₈ monocarboxylic acid, at least one ethylenically unsaturated dicarboxylic acid or derivative thereof, and optionally alkyl(meth)acrylate; and the combined carboxylic acid functionalities are at least partially neutralized to salts with one or more alkali metal, transition metal, or alkaline earth cations.

The composition can be a flexible polyamide composition with flex modulus in the range of 50 to 150 kpsi that has excellent salt stress crack resistance. This addresses the poor salt stress crack resistance of polyamides with a higher ratio of amide to methylene groups, such as nylon-6 and nylon-66.

The flexible polyamide composition has excellent impact toughness.

The flexible polyamide composition has excellent salt stress crack resistance, excellent impact toughness, and good optical clarity. This addresses the unmet need of polyamides with a higher ratio of amide to methylene groups, such as nylon-11 and nylon-12.

Also provided is an article comprising or produced from the composition wherein the article can be a polymeric film. The polymeric film may contain more than one layer and may adhere to a woven or nonwoven textile. The article comprises tubing, hose, pipe, injection molded parts etc.

### DETAILED DESCRIPTION OF THE INVENTION

All references disclosed herein are incorporated by reference.

Unless stated otherwise, all percentages, parts and ratios, are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range having a lower limit of 0, such component is an optional component (i.e., it may or may not be present). Such optional components, when present, are included in an amount preferably of at least about 0.1 weight % of the total weight of the composition or polymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. However, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

Thermoplastic resins are polymeric materials that can flow when heated under pressure.

Any polyamides (abbreviated PA), also referred to as nylons, produced from lactams or amino acids, known to one skilled in the art, may be used in the composition. Polyamides from single reactants such as lactams or amino acids, referred to as AB type polyamides are disclosed in Nylon Plastics (edited by Melvin L. Kohan, 1973, John Wiley and Sons, Inc.) and include nylon-6, nylon-11, nylon-12, or combinations of two or more thereof. Polyamides prepared from more than one lactam or amino acid include nylon-6,12. Frequently used polyamides include nylon-6, nylon-11, nylon-12, and nylon-6,12 or combinations of two or more thereof. Preferred polyamides are of the AB type.

Other well known polyamides useful in the composition include those prepared from condensation of diamines and diacids, referred to as AABB type polyamides (including nylon-66, nylon-610, nylon-612, nylon-1010, and nylon-1212) as well as from a combination of diamines and diacids such as nylon-66/610, or combinations of two or more thereof. Polyamides based on a mixture of nylon-66 and nylon-6 may be useful if the presence of nylon-66 is less than 40 weight % of the polyamide mixture.

Non-aliphatic polyamides including poly(m-xylene adipamide) (such as nylon MXD6 from Mitsubishi Gas Chemical America Inc.) or amorphous polyamide produced from hexamethylene diamine and isophthalic/terephthalic acids (such as SELAR PA from E. I. du Pont de Nemours and Company (DuPont)) may be used.

Because polyamides and processes for making them are well known to one skilled in the art, disclosure of their preparation is omitted herein for the interest of brevity.

(Meth)acrylic acid refers to acrylic acid, methacrylic acid, or both. (Meth)acrylate refers to acrylate, methacrylate, or both.

“Sheets” and “films” may be used interchangeably to describe articles wherein the compositions are processed into generally planar forms, either monolayer or multilayer. The processing method and/or the thickness may influence whether the term “sheet” or “film” is used herein, but either term can be used to describe such generally planar articles.

The ionomers contain in-chain copolymerized units of ethylene, copolymerized units of an α,β-unsaturated C₃-C₈ monocarboxylic acid and copolymerized units of at least one ethylenically unsaturated dicarboxylic acid comonomer selected from C₄-C₈ unsaturated acids having at least two carboxylic acid groups, cyclic anhydrides of C₄-C₈ unsaturated acids having at least two carboxylic acid groups, and monoesters (wherein one carboxyl group of the dicarboxylic moiety may be esterified and the other is a carboxylic acid) of C₄-C₈ unsaturated acids having at least two carboxylic acid groups; at least partially neutralized to salts comprising alkali metal, transition metal, or alkaline earth metal cations, such as lithium, sodium, potassium, magnesium, calcium, or zinc, or a combination of such cations.

The α,β-unsaturated C₃-C₈ monocarboxylic acid may be acrylic acid or methacrylic acid, and the monocarboxylic acid may be present in the copolymer in an amount from about 0.5 to about 20 weight %, or about 3 weight % to about 20 weight %, or about 4 weight % to about 15 weight % of the copolymer.

The ionomers may contain the ethylenically unsaturated dicarboxylic acid or its derivative in an amount from about 0.5 to about 15%, or about 3% to about 12%, or about 4% to about 10% of the copolymer. The unsaturated dicarboxylic acid comonomers include, for example, maleic acid, fumaric acid, itaconic acid, and C₁-C₄ alkyl monoesters of maleic acid (such as ethyl hydrogen maleate), fumaric acid, itaconic acid or combinations of two or more thereof.

The dicarboxylic acid or its derivative is maleic acid, fumaric acid, itaconic acid, maleic anhydride, fumaric anhydride, itaconic anhydride, maleic acid monoester, fumaric acid monoester, itaconic acid monoester, or combinations of two or more thereof;

The ionomer may also optionally include other comonomers such as alkyl(meth)acrylates wherein the alkyl groups have from 1 to 8 carbon atoms such as methyl acrylate, ethyl acrylate and n-butyl acrylate. The alkyl(meth)acrylates, when present, can be from 0.1 to about 30% based on the total weight of the copolymer, or about 0.1 to about 15%. The optional alkyl(meth)acrylates provide softer resins that after neutralization form softer ionomers.

Of note are ionomers with 0% of alkyl(meth)acrylates. Ionomers are made from ethylene acid copolymers in which the total of (meth)acrylic acid and dicarboxylic acid monomers can be from about 4 to about 26%, and the total comonomer content does not exceed 50%, based on the total weight of the copolymer.

The acid copolymers may be obtained by high-pressure free radical polymerization, wherein the comonomers are directly copolymerized with ethylene by adding all comonomers simultaneously. This process provides copolymers with “in-chain” copolymerized units derived from the monomers, where the units are incorporated into the polymer backbone or chain. These copolymers are distinct from a graft copolymer, in which the acid comonomers are added to an existing polymer chain via a post-polymerization grafting reaction, often by a free radical reaction. Some non-neutralized ethylene acid copolymers comprising ethylenically unsaturated dicarboxylic acid comonomers are known (e.g., U.S. Pat. No. 5,902,869) as are their ionomeric derivatives (e.g., U.S. Pat. No. 5,700,890).

Examples include copolymers of ethylene, methacrylic acid and ethyl hydrogen maleate (E/MAA/EHM), copolymers of ethylene, acrylic acid and maleic anhydride (E/AA/MAH), copolymers of ethylene, methacrylic acid, ethyl hydrogen maleate and ethyl acrylate (E/MAA/EHM/EA), copolymers of ethylene, acrylic acid, maleic anhydride and methyl acrylate (E/AA/MAH/MA), or combinations of two or more thereof.

These copolymers can be at least partially neutralized to form salts with one or more alkali metal, transition metal, or alkaline earth metal cations.

Neutralization of an ethylene acid copolymer can be effected by first making the ethylene acid copolymer and treating the copolymer with basic compound(s) comprising alkali metal, alkaline earth metal and/or transition metal cations. The copolymer may be neutralized so that from about 10 to about 99.5% of the available carboxylic acid groups in the copolymer are neutralized to salts with at least one metal ion selected from lithium, sodium, potassium, magnesium, calcium, barium, lead, tin, zinc, aluminum; or combinations of such cations. For example, from about 10 to about 70 or about 35 to about 70% of the available carboxylic acid groups may be ionized by treatment with a basic compound (neutralization) with at least one metal ion selected from sodium, zinc, lithium, magnesium, and calcium; and more preferably sodium, zinc or magnesium. Examples include anhydride ionomers comprising sodium or zinc as a cation. Methods for preparing anhydride ionomers from the copolymers are known in the art (e.g., U.S. Pat. No. 5,700,890).

The blend may comprise, consist essentially of, consist of, or be produced from, about 50 to about 70, or about 55 to about 65% of a polyamide and about 30 to about 50, 35 to about 55, about 35 to about 45% of an anhydride ionomer, all based on the total weight of the blend.

Of note is a blend in which the polyamide and the anhydride ionomer are present in about a 3:2, or about a 1:1, or about a 2:3 ratio.

A sulfonamide can be used as plasticizer when added to a blend of polyamide and anhydride ionomer so that it retains its flexibility under use conditions particularly when subject to elevated temperatures. The sulfonamide can be used in an amount of about 2 to about 20% and preferably from about 5 to about 15%, based on the total weight of the composition. The sulfonamide may be an alkyl aryl sulfonamide, where the alkyl group has 1 to 4 carbon atoms such as n-methyl benzene sulfonamide, n-ethyl benzene sulfonamide, n-propyl benzene sulfonamide, n-isopropyl benzene sulfonamide, n-isobutyl benzene sulfonamide, n-butyl benzene sulfonamide, or combinations of two or more thereof. The n-butyl benzene sulfonamide is readily available and provides optimum flexibility to articles made from the composition.

Of note is a composition as described herein consisting essentially of a (1) polyamide; (2) an ionomer comprising a copolymer having (a) in-chain copolymerized units of ethylene; (b) in-chain copolymerized units of an α,β-unsaturated C₃-C₈ monocarboxylic acid; (c) in-chain copolymerized units of at least one dicarboxylic acid or derivative thereof; and optionally (d) in-chain copolymerized units of alkyl acrylate or alkyl methacrylate; and (3) a sulfonamide, wherein the composition does not comprise any additional thermoplastic materials.

The composition or blend can optionally comprise additional thermoplastic materials blended with the polyamide, ionomer, and sulfonamide to allow one to more easily modify the properties of the composition by manipulating the amount and type of additional components present in the composition in addition to varying the percentages of the monomers in the ethylene acid copolymer; or to allow for easier, lower cost manufacture of the composition by allowing one to prepare fewer base resins that can be subsequently modified to obtain desired properties, or to substitute a portion of the composition with a less expensive material. To retain the desired benefits, the additional thermoplastic material may be present in the composition in an amount up to about 30% of the total composition, such as from 1 to 10, 15 or 20%. Other thermoplastic materials that may be used include non-ionomers and/or ionomers.

For example, a portion of the ionomer described above can be substituted with conventional ionomer(s) containing only monocarboxylic acid units. The composition or blend may further include one or more E/X/Y copolymers where E is ethylene, X is a C₃₋₈ α,β-ethylenically unsaturated monocarboxylic acid, and Y is one or more alkyl(meth)acrylates as disclosed above, or ionomers thereof. X is present in from about 2 to about 30% and Y is present from 0 to about 40%, based on the weight of the E/X/Y copolymer, where the carboxylic acids can be at least partially neutralized to salts with one or more metal ions as disclosed above. Of note are E/X/Y terpolymers wherein Y is present from about 0.1 to about 40 weight % of the copolymer. Also of note are E/X/Y copolymers wherein Y is 0 weight % of the copolymer (that is, E/X dipolymers).

When such E/X/Y copolymers or ionomers are added, the E/X/Y copolymers can substitute for up to half (50% by weight) of the ionomer comprising repeat units derived from dicarboxylic acid(s) in component (2) of the composition. Non-limiting, illustrative examples of E/X/Y copolymers (including acid copolymer, ionomer of the acid copolymer, or combinations thereof) include E/15MAA, E/19MAA, E/15AA, E/19AA, E/15MAA, E/19MAA, E/10MAA/4iBA, E/10MAA/9.8iBA, E/9MAA/23nBA, E/15MAA/Na, E/19MAA/Na, E/15AA/Na, E/19AA/Na, E/15MAA/Mg, E/19MAA/Li, E/10MAA/4iBA/Na, E/10MAA/9.8iBA/Zn and E/9MAA/23nBA/Mg (wherein E represents ethylene, MAA represents methacrylic acid, AA represents acrylic acid, iBA represents isobutyl acrylate, nBA represents n-butyl acrylate, the numbers represents the weight % of comonomers present in the copolymer and the atomic symbol represents the neutralizing cation).

Of note is a composition as described herein consisting essentially of a (1) polyamide; (2) an ionomer comprising a copolymer having (a) in-chain copolymerized units of ethylene; (b) in-chain copolymerized units of an α,β-unsaturated C₃-C₈ monocarboxylic acid; (c) in-chain copolymerized units of at least one dicarboxylic acid or derivative thereof; and optionally (d) in-chain copolymerized units of alkyl acrylate or alkyl methacrylate; and (3) a sulfonamide wherein a portion of the ionomer of (2) comprising a copolymer having in-chain copolymerized units of at least one dicarboxylic acid or derivative thereof is substituted with an ionomer comprising a copolymer having in-chain copolymerized units of monocarboxylic acid and no copolymerized dicarboxylic acid units (an E/X/Y copolymer as described above); and no other non-ionomeric thermoplastic materials.

Non-ionomers include copolyetheramides, elastomer polyolefins, styrene diene block copolymers (e.g., styrene-butadiene-styrene (SBS)), thermoplastic elastomers, thermoplastic polyurethanes (e.g., polyurethane), polyetherester, polyamideether, polyether-urea, PEBAX (a family of block copolymers based on polyether-block-amide, commercially supplied by Atochem), styrene(ethylene-butylene)-styrene block copolymers, etc., polyesters, polyolefins (e.g., polyethylene, polypropylene, or ethylene/propylene copolymers), ethylene copolymers (with one or more comonomers including vinyl acetate, (meth)acrylates, (meth)acrylic acid, epoxy-functionalized monomer, CO, etc., functionalized polymers with maleic anhydride, or epoxidization), grafting, elastomers such as EPDM, metallocene catalyzed PE and copolymer, ground up powders of the thermoset elastomers, or combinations of two or more thereof.

The composition or blend can comprise 0.0001 to about 10%, based on the weight of the composition or blend, of optional additives including stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, or combinations of two or more thereof. Of note is a composition as described herein consisting of a (1) polyamide; (2) an ionomer comprising a copolymer having (a) in-chain copolymerized units of ethylene; (b) in-chain copolymerized units of an α,β-unsaturated C₃-C₈ monocarboxylic acid; (c) in-chain copolymerized units of at least one dicarboxylic acid or derivative thereof; and optionally (d) in-chain copolymerized units of alkyl acrylate or alkyl methacrylate; and (3) a sulfonamide, further containing at least one additive as described above.

The blend may be produced by any means known to one skilled in the art, e.g., dry blending/mixing, extruding, co-extrusion, to produce the composition. The composition may be formed into articles by various means known to those skilled in the art. For example, the composition may be extruded, laminated, molded (e.g. injection molded, blow molded or overmolded), cut, milled or the like to provide an article that is in a desired shape and size; or be cast or blown into a sheet or film.

Articles comprising the thermoplastic composition also may be further processed. For example, portions of the composition (such as, but not limited to, pellets, slugs, rods, ropes, sheets and molded or extruded articles) may be subjected to thermoforming operations in which the composition is subjected to heat, pressure and/or other mechanical forces to produce shaped articles. Compression molding is an example of further processing.

A multilayer structure such as a film may be made from a layer comprising the polyamide, anhydride ionomer and plasticizer composition and at least one other layer comprising a composition other than that composition. The layers may be coextruded or they may be formed independently and then adhesively attached to one another to form an article. For example, additional layers may comprise or be produced from thermoplastic resins, to which the layer made from the composition is adhered, to provide structure layers, to provide protection or improve the appearance of the article. Examples include multilayer films comprising ionomers or non-ionomers disclosed above as at least one additional layer.

Molten extruded polymers can be converted into a film using any techniques known to one skilled in the art. For example, a film can also be made by coextrusion followed by lamination onto one or more other layers. Other converting techniques are, for example, blown film extrusion, cast film extrusion, cast sheet extrusion and extrusion coating.

A multilayer film may be prepared by coextrusion. For example, granulates of the compositions or components thereof are melted in extruders to produce molten polymeric resins, which are passed through a die or set of dies to form layers of molten polymers that are processed as a laminar flow. The molten polymers are cooled to form a layered structure.

A film can be further oriented beyond the immediate quenching or casting of the film. The process comprises the steps of (co)extruding a laminar flow of molten polymers, quenching the (co)extrudate and orienting the quenched (co)extrudate in at least one direction. The film may be uniaxially oriented, or it can be biaxially oriented by drawing in two mutually perpendicular directions in the plane of the film to achieve a satisfactory combination of mechanical and physical properties.

Orientation and stretching are well known to one skilled in the art and the description of which is omitted herein for the interest of brevity.

A monolayer or multilayer film could be further processed by thermoforming into a shaped article. For example, a sheet of the multilayer structure could be formed into a casing element for a portable communication device.

An article may also be fabricated by extrusion coating or laminating some or all of the layers onto a substrate where the film is the surface layer meaning that it one side of its surface is not attached to any other object. Examples of articles include an article comprising the composition transformed into a transparent protective scratch-resistant film or sheet or outside (top) layer on a scratch-exposed object such as a transparent scratch-resistant layer on auto interior or exterior applications, for flooring tiles or sheets, for a sporting good, or as packaging film for dry abrasive goods.

The substrate can be a film or sheet comprising or derived from polyvinyl chloride, ethylene vinyl acetate copolymer, ethylene propylene diene (EPDM) elastomer, polypropylene, ethylene copolymer, cellulosic material, wood fiber, ionomer, polyamide, polyester, polyurethane, styrenic polymer, acrylonitrile-butadiene-styrene copolymer, nonwoven materials, nonpolymer materials (e.g., glass, paper, wood, stone, or metal foil). or combinations of two or more thereof.

The film or sheet may be laminated to the substrate, for example, by coextrusion, extrusion coating or any lamination techniques.

The film or sheet includes monolayer or multilayer film or sheet that may be used as, for example, a transparent, translucent and/or printed decorative or protective scratch-resistant film or sheet on an article.

Decorative films may be used as a surface treatment on many consumer articles to provide decoration and surface protection. These films have increasingly replaced other surface treatments such as coatings, paint, and lacquers due to their ease of application and durability compared to traditional coatings. They provide more economic and environmentally compatible options compared to conventional multistep coating methods. Decorative films also allow for more freedom of design and customization than traditional coatings. They may be provided with decorative elements such as by printing, embossing and the like prior to their application to a consumer article. Multilayer films may also be used, for example, so-called “lacquer films” having shiny metallic or other effect fillers.

The multilayer structure can be adhered to a shaped article to provide a protective layer. For example, multilayer structure can be thermoformed by heat and/or pressure to adhere to a substrate to form an automotive part or a sporting good. Examples of articles that comprise the multilayer structure disclosed above can include flooring, furniture films, ski top layers, auto interior top layers, auto exterior scratch resistant top layers, or coverings for steps in stair cases.

Usually the bottom layer of a floor covering can be polyvinyl chloride, ethylene vinyl acetate copolymer, ethylene methyl acrylate copolymer, ethylene butyl acrylate copolymer, or EPDM which can be highly filled (30-95%) with fillers such as clay, CaCO₃, or talc. In between the surface layer and the bottom layer, it may include a polyester or polypropylene nonwoven layer. Glass fibers can be used between the filled bottom layer and the surface layer. The surface layer can be clear and transparent such that a printable film layer can be included between the surface layer and the substrate. In many cases the print can be applied either to the surface layer (i.e., reverse printing) or to the bottom layer or to an intermediate layer (can be a polymer film) that is inserted in between the filled bottom layer and the surface layer. In that case the adhesive layer may be inserted.

In wood flooring (e.g., parketts), the bottom layer is a natural material (wood or cork) which can be printed with some kind of color. It may be desirable to insert an adhesive layer between wood and the surface layer that can adhere to this color. Any known adhesive can be used.

The surface cover for the wood flooring where the substrate is wood or wood fiber or wood flour can include a maleic acid-grated ethylene copolymer such as ethylene vinyl acetate, a regular SURLYN® (i.e., ionomer without the dicarboxylic acid comonomer), or ethylene methyl acrylate. The thickness of surface layer can be 100-200 mμ and the thickness of the entire multilayer structure can be 300-600 mμ.

In furniture, the substrate can be MDF (compression molded wood such as that using polyvinyl chloride), compressed wood, or polypropylene film or sheet coated with polyurethane. The thickness of such multilayer structure may be 200 mμ.

When used as sKi top layer, the multilayer structure can be up to 1000 mμ thick. The surface layer may be coextruded with ski substrate, which can be anything from wood to ABS.

In application for auto Interior part top layers, the multilayer structure can be adhered to polypropylene or metal substrate.

As to auto exterior scratch resistant top layers, the substrate can be an ionomer that is clear or pigmented and the surface layer is clear to provide scratch- or scuff-resistance.

The multilayer structure can also be used as coverings for steps in stair cases where the surface layer can be adhered, using for example, a pressure sensitive adhesive, to the substrate, which is the stir case, wood, metal, rock, or stone.

The multilayer structure may also be used for other wear- and scratch-exposed objects such as seal layers in packaging structures that contain hard, abrasive objects such as dry soup mixes. Here, the surface or to layer can be heat sealed to another substrate or another film or sheet structure. Such another substrate can be metal surface, metal, metal foil, paperboard, stone, leather, or any of the substrates disclosed above.

The decorative films may be used on sporting goods such as skis, snowboards, boots, shoes, rackets and the like. Many other consumer articles such as textiles, flatware, flooring and household appliances may also incorporate decorative films. Automotive, motorcycle and other vehicle parts may be embellished with decorative films. The films may also be used as advertising media for application to signs, buses, trucks, railroad cars. Films may also be used for large-area decoration of floors or building facades.

Polyamide-12 and polyamide-12 elastomers may be preferred for these decorative film applications, offering a good combination of transparency, mechanical properties and chemical resistance.

The composition may also be adhered to shaped substrates by injection molding, overmolding or compression molding. For example, films comprising the composition may be placed in an injection mold and the bulk polymeric material of the part injected behind the film to provide a decorated article in a single operation.

The compositions may also be shaped by profile extrusion. A profile is defined by having a particular shape and by its process of manufacture is known as profile extrusion. A profile is not film or sheeting, and thus the process for making profiles does not include the use of calendering or chill rolls, nor is it prepared by injection molding processes. A profile is fabricated by melt extrusion processes that begin by (co)extruding a thermoplastic melt through an orifice of a die (annular die with a mandrel) forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. A common shape of a profile is tubing or hoses. Monolayer or multilayer tubing may be prepared.

Tubing assemblies for the transport of liquids and vapors are well known in the art. Clarity of the tubing may be desirable for visual observation of the fluids being transferred. Furthermore, depending on the use of the tubing, there may be exposure to extremely low temperatures and/or extremely high temperatures. The compositions as described herein provide a good combination of toughness, flexibility and clarity, making them suitable for preparation of profiles such as tubing.

The composition may be profile extruded to provide articles such as hoses for air conditioning; refrigeration; dispensing and transfer equipment for fluids including foods and beverages, compressed air or gases, paint, chemicals such as solvents, alkalis, dilute mineral or organic acids, and the like, petroleum products, fuel and oil; coolant lines, grease lines, hydraulic lines, auto hoses or tubing, laboratory uses, instrumentation, etc.

The polyamide composition described herein may be used as the polymeric composition for hoses in which surface temperatures in operation may be up to about 90° C. The composition provides desired flexural modulus and improved aging compared to previous compositions.

With some tubular shapes, support means such as fiber or metal reinforcement may be used to assist in shape retention. Reinforcement may be in the form of braided reinforcing layers around the outside surface of a base tube of the composition or incorporated between layers of polymeric material. The reinforcing layers may include braided polyester, polyamide or aramid fibers. Adhesives may be used to adhere the reinforcing layer to the composition. For example, U.S. Pat. No. 4,130,139 discloses crosslinked polyurethane used as an adhesive for bonding polyamide-11 to such reinforcing layers. In some cases, the thermoplastic material may be melt processed so that it fills the voids between strands or braids of reinforcing material, resulting in the reinforcing material embedded within a layer of the composition.

Flexible pipes or liners for oil or gas pipelines may also comprise the composition. In the operation of offshore oil or gas deposits it is necessary to use flexible pipes to connect the various devices around the platform. The pipes must withstand hot oil, gas, water and mixtures of at least two of these products for periods possibly as long as 20 years. Excellent salt stress crack resistance is also important for these applications. These pipes may consist of a non-impermeable metal inner layer formed by a profiled metal tape wound in a helix, such as an interlocked strip, which gives the pipe shape, a polymeric composition extruded over this layer in order to provide sealing and, finally, other protective and reinforcing layers, such as metal fiber plies and rubber plies.

U.S. Pat. No. 6,913,043, WO2004/052993, WO2007/041722, and WO2007/041723 describe various pipe and tubing uses and constructions using prior polyamide compositions. The composition disclosed herein may be used as an alternative polyamide composition for use in those applications and constructions.

### EXAMPLES

The following Examples are merely illustrative, and are not to be construed as limiting the scope of the invention.

### Materials

For the materials listed below, Relative viscosity (RV) was reported by the commercial supplier.

N-12-A: Nylon-12 extrusion grade with a melting point of 180° C., available under the tradename RILSAN® AESNO TL from Arkema Inc.

N-12-B: Nylon-12 molding grade with a melting point of 180° C., available under the tradename RILSAN® AMNO from Arkema Inc.

N-6-A: nylon-6, RV of 2.62-2.83 measured according to ISO 307, available under the tradename ULTRAMID® B27-E01 from BASF.

N-6-B: nylon-6, RV of 3.09 to 3.22 measured according to ISO 307, available under the trade name ULTRAMID® B32 from BASF.

N-6-C: nylon-6, RV of 3.19-3.41 measured according to ISO 307, available under the tradename ULTRAMID® B35 from BASF.

Al-1: anhydride ionomer terpolymer comprising ethylene, 11 weight % of methacrylic acid and 6 weight % of ethyl hydrogen maleate;

nominally 60% of the available carboxylic acid moieties were neutralized to salts with zinc cations.

MAG-1: a maleic anhydride-grafted linear low density polyethylene with a density of 0.86 g/cc and MFI of 1.6, available under the tradename FUSABOND® 493D from DuPont.

Ion-1: a copolymer comprising ethylene and 15 weight % of methacrylic acid; nominally 60% of the available carboxylic acid moieties were neutralized with zinc cations.

Zinc stearate, commercial grade, used as a processing aid.

N-Butylbenzene sulfonamide, UNIPLEX 214 from Unitex Chemical Corp.

Extrusion/Processing Conditions

All samples were made on a 30-mm twin-screw extruder, typically with 260° C. barrel temperature settings and screw speed of 300 rpm. Polyamide, modifier and zinc stearate (when used) were fed at the back end of the extruder, followed by an intense kneading section in the extruder screw to disperse these ingredients. Plasticizer was injected into the extruder barrel after the initial mixing section, and this liquid injection was followed by additional intense mixing elements. The melt strand from the extruder was water quenched and cut into pellets for collection and subsequent molding and evaluation.

Injection Molding

Testing specimens were molded on either a 1.5 oz Arburg or a 6 oz Nissei injection molding machine, using a standard screw and nozzle. Barrel settings were typically 260° C., and injection pressure and cycle time were adjusted to accommodate the melt viscosity of the given sample.

Methods Employed for Testing

The Flex Modulus was measured according to ASTM D790 with injection molded specimens.

The tensile strength and elongation at break were measured according to ASTM D1708, “Standard Test Method for Tensile Properties of Plastics by use of Microtensile Specimens” using crosshead speed of 10 in/min. Test area of specimens was 0.185 inch width×0.125 inch thickness×0.875 inch length.

The notched Izod impact was measured using ASTM D256 with injection-molded specimens. Flex bars (5 inch×0.5 inch×0.125 inch) were cut into “gate end” (closest to melt entrance to mold) and “far end” (most distant from melt entrance into mold) and notched according to the ASTM D256 standards. Izod impact reported were the average of Izod impact results of gate and far specimens. Sub-ambient samples were conditioned at the specified temperature in a liquid carbon dioxide chamber and then measured immediately.

For optical testing, either extruded cast film or compression molded films were used. The extruded cast films of about 10 mil thickness were prepared using a twin screw extruder with 260° C. barrel settings. The compression molded films were prepared using a heated press with temperature set at 260° C. to compress to 40,000 psi in a 10 mil chase. In Tables 3 and 4, “C” indicates cast film and “M” indicates compression molded film.

Optical properties were measured according to ASTM D1003 using the instrument of HunterLab Colorquest XE Spectrophotometer; mode, transmittance; color scale, C.I.E XYZ; Illuminant/Angle, D65/10°. Transmission haze is defined as the forward scattering of light from the surface of a nearly clear specimen viewed in transmission. When measuring haze, the percentage of the light diffusely scattered is compared to the total light transmitted according to the formula:

% haze=Y_{diffused} divided by Yₜₒₜₐₗ×100.

The environmental stress cracking test was measured according to ASTM D1693. The purpose of this test is to measure the chemical resistance of a compound by artificially stimulating a stress introduced into a sample by means of a stress crack or “nick.” The sample is then bent and subjected to a chemical solution of 50% by weight of Zinc Chloride at room temperature for 168 hrs. Ten specimens of each composition sample were used. The size of the test specimen was 1.5 inch long×0.5 inch wide×0.125 inch thick. The test specimens were nicked, then placed into a holder so that they were held in a bent configuration with the nicked side facing up. The specimens were then immersed in 50 weight percent aqueous zinc chloride solution. The specimens were inspected periodically for formation of cracks which indicated failure of the specimen. At the end of 168 hrs, the percentage of the total number of failures out of the ten specimens tested was recorded. For example, 80% means that 8 out of 10 specimens failed.

### Examples 1 to 11 and Comparative Examples C1 to C3

Compositions using nylon-6 were prepared and processed into test specimens as described above using the components summarized in Table 1. The properties are summarized in Table 2.

TABLE 1

| | Nylon 6 | | Modifier | | Zinc Stearate | Plasticizer |
|---|---|---|---|---|---|---|
| Example | Type | % | Type | % | % | % |
| C1 | N-6-A | 88 | None | 0 | 0 | 12 |
| C2 | N-6-C | 94 | None | 0 | 0 | 6 |
| C3 | N-6-C | 88 | None | 0 | 0 | 12 |
| C4 | N-6-A | 55.2 | MAG-1 | 36.8 | 0 | 8 |
| C5 | N-6-A | 52.8 | MAG-1 | 35.2 | 0 | 12 |
| C6 | N-6-A | 52.8 | Ion-1 | 35.2 | 0 | 12 |
| 7 | N-6-A | 55.93 | AI-1 | 37.365 | 0.705 | 6 |
| 8 | N-6-A | 54.74 | AI-1 | 36.57 | 0.69 | 8 |
| 9 | N-6-A | 52.8 | AI-1 | 35.2 | 0 | 12 |
| 10 | N-6-A | 52.36 | AI-1 | 34.98 | 0.66 | 12 |
| 11 | N-6-A | 52.36 | Ion-1 | 17.49 | 0.66 | 12 |
| | | | AI-1 | 17.49 | | |
| 12 | N-6-B | 55.93 | AI-1 | 37.365 | 0.705 | 6 |
| 13 | N-6-B | 54.74 | AI-1 | 36.57 | 0.69 | 8 |
| 14 | N-6-C | 52.36 | Ion-1 | 17.49 | 0.66 | 12 |
| | | | AI-1 | 17.49 | | |
| 15 | N-6-C | 55.93 | AI-1 | 37.365 | 0.705 | 6 |
| 16 | N-6-C | 54.74 | AI-1 | 36.57 | 0.69 | 8 |
| 17 | N-6-C | 53.55 | AI-1 | 35.78 | 0.675 | 10 |
| 18 | N-6-C | 52.36 | AI-1 | 34.98 | 0.66 | 12 |

TABLE 2

| | Flex | Salt Stress | | | |
|---|---|---|---|---|---|
| | Modulus | Cracking | Notched Izod, ft · lb/in | | |
| Example | (Kpsi) | (%) | Room temperature | 0° C. | −20° C. |
| C1 | 145.0 | 100* | 0.6 | NA | NA |
| C2 | 217.6 | 80 | | 1.7 | 0.3 |
| C3 | 115.0 | 100* | 0.9 | NA | NA |
| C4 | 49.8 | NA | 15.27 | 18.9 | 20.85 |
| C5 | 36.2 | NA | 14.50 | 14.1 | 21.7 |
| C6 | 68.9 | NA | 23.76 | 16.08 | 3.20 |
| 7 | 99.3 | 0 | NA | 7.7 | 2.8 |
| 8 | 84.5 | 0 | NA | 18.6 | 3.0 |
| 9 | 72.9 | NA | 26.38 | 20.1 | 2.76 |
| 10 | 51.5 | NA | 22.45 | 7.67 | 4.89 |
| 11 | 54.0 | NA | 24.16 | NA | NA |
| 12 | 93.5 | 0 | NA | 22.3 | 6.0 |
| 13 | 75.6 | 0 | NA | 25.8 | 4.5 |
| 14 | 48.8 | NA | 23.59 | NA | NA |
| 15 | 92.0 | 0 | NA | 26.0 | 4.6 |
| 16 | 68.8 | 0 | NA | 27.0 | 11.2 |
| 17 | 58.8 | 0 | 24.4 | 22.8 | 23.6 |
| 18 | 52.3 | 100 | 25.6 | 23.9 | 24.8 |

Plasticized nylon 6 (Comparative Examples C1, C2, C3) had poor salt stress crack resistance and poor impact resistance even at ambient temperature. Even using 12% plasticizer, these materials had high flexural modulus. Comparative Examples C1 and C3, containing 12 weight % of plasticizer, failed the ZnCl₂ salt test within one hour.

All examples of Nylon-6 modified with anhydride ionomer Al-1 and plasticizer showed significant improvements in flexural modulus and toughness (as indicated by notched Izod). Examples 7, 8, 12, 13, 15, 16 and 17 with plasticizer in moderate amounts (10% or less) showed balanced properties, attaining high flexibility and excellent impact resistance at low temperatures, and most importantly achieving excellent ZnCl₂ salt stress crack resistance. Example 18, with plasticizer at high loading (12%), had excellent toughness, even at low temperatures, but showed poor ZnCl₂ salt stress crack resistance.

As summarized in Table 3, films prepared from plasticized nylon-6 modified with either a maleic anhydride graft copolymer or a conventional ionomer, with only monocarboxylic acid comonomer, which showed excellent toughness at low temperatures, were compromised in optical quality, with high haze and reduced transmitted light. Also, the film samples prepared from plasticized nylon-6 modified with a maleic anhydride graft copolymer appeared to have poor scratch resistance assessed by finger-nail scratching. In contrast, Example 9 provided both excellent toughness and good optical properties.

TABLE 3

Optical Properties

| | | | Total Light |
|---|---|---|---|
| Example | | Haze % | Transmitted % |
| C4 | “M” | 56.76 | 82.86 |
| C5 | “M” | 77.86 | 75.62 |
| C6 | “M” | 59.81 | 86.02 |
| 9 | “M” | 34.51 | 93.16 |

### Example 19

A composition comprising 52.36% nylon N-6-C, 34.98% anhydride ionomer Al-1, 0.66% zinc stearate, and 12% n-butyl benzenesulfonamide was compounded on a 40 mm twin-screw extruder, quenched, and pelletized. This material was dried at about 70° C. and then extruded into 0.5-inch diameter tubing (0.043 inch wall thickness) on a 1.5-inch single screw extruder with a general purpose screw at about 5.5 ft/min. Extruder barrel temperature settings were 210° C. to 243° C. and adapter and die temperature settings were 240° C. Melt temperature was measured at 224° C., and the material had excellent melt strength. The freshly extruded tubing was passed through air for a short distance, vacuum sized by passing through a vacuum chamber and quenched in water. The tubing had a semi-gloss appearance with excellent scratch resistance. Based on surface feel, plasticizer does not seem to migrate out of the polymer.

### Examples 22, 23, 26 and 27 and Comparative Examples C20, C21, C24 and C25

Compositions using nylon 12 were prepared and processed into test specimens as described above using the components summarized in Table 4. Films were prepared and their optical properties were measured as described above. “TLT” means Total Light Transmitted. The mechanical properties are summarized in Table 5.

TABLE 4

| Ex. | Nylon 12 | Modifier | Nylon (%) | Modifier (%) | Plasticizer (%) | Film | Haze (%) | TLT % |
|---|---|---|---|---|---|---|---|---|
| C20 | N-12-A | none | 88.0 | 0 | 12 | “C” | 4.42 | 91.64 |
| C21 | N-12-A | MAG-1 | 52.8 | 35.2 | 12 | “M” | 71.54 | 84.1 |
| 22 | N-12-A | AI-1 | 55.2 | 36.8 | 8 | “M” | 36.83 | 92.44 |
| 23 | N-12-A | AI-1 | 52.8 | 35.2 | 12 | “M” | 39.65 | 92.98 |
| C24 | N-12-B | none | 88.0 | 0 | 12 | “C” | 7.92 | 92.92 |
| C25 | N-12-B | MAG-1 | 52.8 | 35.2 | 12 | “C” | 59.03 | 87.34 |
| 26 | N-12-B | AI-1 | 55.2 | 36.8 | 8 | “C” | 12.81 | 91.02 |
| 27 | N-12-B | AI-1 | 52.8 | 35.2 | 12 | “C” | 13.1 | 90.67 |

TABLE 5

| | Flexural | Tensile Strength | Elongation at | Notched Izod, ft · lb/in | | |
|---|---|---|---|---|---|---|
| Example | Modulus (Kpsi) | (Kpsi) | Break (%) | Room Temp (23° C.) | 0° C. | −20° C. |
| C20 | 55.6 | 5.8 | 357 | 20.1 | 9.0 | 0.9 |
| C21 | 25.4 | 3.2 | 251 | 7.3 | 11.0 | 17.2 |
| 22 | 74.2 | 5.4 | 237 | 19.1 | 19.1 | 18.5 |
| 23 | 53.8 | 4.3 | 211 | 14.0 | 19.1 | 20.3 |
| C24 | 74.6 | 6.0 | 404 | 0.6 | 0.7 | 0.3 |
| C25 | 27.2 | 3.2 | 412 | 9.3 | 12.9 | 17.6 |
| 26 | 59.8 | 4.7 | 375 | 18.9 | 21.7 | 10.7 |
| 27 | 53.9 | 4.6 | 391 | 15.4 | 20.4 | 13.0 |

Plasticized nylon-12 (C20 and C24) had good optical properties, with very low haze and good light transmission, but showed poor impact resistance at low temperature.

Nylon-12 modified with MAG-1 and plasticizer (Comparative Examples C21 and C25) showed excellent toughness at low temperatures, but were compromised in optical quality, with high haze and reduced transmitted light. The film samples were essentially opaque. Also, the film samples appeared to have poor scratch resistance assessed by finger-nail scratching.

The anhydride ionomer modified nylon-12 with the addition of plasticizer (Examples 22, 23, 26 and 27), showed balanced properties of high flexibility, good scratch resistance and excellent impact resistance even at low temperatures, while retaining low haze and good light transmittance.

1. A composition comprising or produced from, based on the weight of the composition, about 40 to about 70% of polyamide, about 60 to about 30% of an ionomer, and about 2 to about 20% of a sulfonamide wherein the ionomer comprises or is a copolymer derived from in-chain copolymerized comonomers of ethylene, at least an α,β-unsaturated C₃-C₈ monocarboxylic acid; at least one ethylenically unsaturated dicarboxylic acid or derivative thereof; and optionally alkyl (meth)acrylate; and
the combined carboxylic acid functionalities are at least partially neutralized to salts with one or more alkali metal, transition metal, or alkaline earth cations.

2. The composition of claim 1 wherein the monocarboxylic acid includes acrylic acid or methacrylic acid; and the dicarboxylic acid or derivative thereof includes maleic acid, fumaric acid, itaconic acid, maleic anhydride, fumaric anhydride, itaconic anhydride, one or more C₁₋₄ alkyl half ester of maleic acid, one or more C₁₋₄ alkyl half ester of fumaric acid, one or more C₁₋₄ alkyl half ester of itaconic acid, or combinations of two or more thereof.

3. The composition of claim 2 wherein copolymerized units of the monocarboxylic acid are present from about 0.5 to about 20% and the copolymerized units of the dicarboxylic acid or derivative thereof are present from about 0.5 to about 15%, both based on the weight of the copolymer.

4. The composition of claim 3 wherein copolymerized units of alkyl acrylate or alkyl methacrylate are present in the copolymer from 0.1 to about 30 weight %.

5. The composition of claim 2 wherein the copolymer is one when the total of acrylic acid or methacrylic acid and dicarboxylic acid or derivative thereof is from about 4 to about 26%, the total comonomer content does not exceed 50%, based on the total weight of the copolymer.

6. The composition of claim 4 wherein the dicarboxylic acid or derivative thereof include one or more C₁₋₄ alkyl half ester of maleic acid.

7. The composition of claim 2 wherein the dicarboxylic acid or derivative thereof includes one or more C₁₋₄ alkyl half ester of maleic acid and the polyamide includes nylon-6, nylon-11, nylon-12, nylon 6,12, nylon-66, nylon-610, nylon-612, nylon-1010, and nylon-1212 or combinations of two or more thereof.

8. The composition of claim 7 wherein the sulfonamide is an alkyl aryl sulfonamide and the alkyl group has 1 to 4 carbon atoms.

9. The composition of claim 8 wherein the sulfonamide is n-butyl benzene sulfonamide.

10. The composition of claim 2 wherein a portion of the ionomer is substituted with a second ionomer comprising no units of copolymerized dicarboxylic acid.

11. The composition of claim 2 that does not comprise any additional thermoplastic materials.

12. The composition of claim 2 further comprising non-ionmeric thermoplastic materials.

13. The composition of claim 2 comprising about 50 to about 70 weight % of the polyamide and about 30 to about 50 weight % of the ionomer.

14. The composition of claim 1 wherein the weight ratio of the polyamide to the ionomer is about a 3:2.

15. An article comprising or produced from a composition wherein the composition is as recited in claim 1.

16. The article of claim 15 wherein the article is flexible when subject to elevated temperatures.

17. The article of claim 15 wherein the article is monolayer film, monolayer sheet, multilayer film, or multilayer sheet and at least one layer comprises the composition.

18. The article of claim 17 wherein the film or sheet is adhered to a woven textile or nonwoven textile.

19. The article of claim 16 wherein the article is a profile.

20. The article of claim 18 wherein the article is a hose, tubing, or pipe.
